(19) United States
(12) Patent Application Publication
(10) Pub. No.: US 2024/0177203 A1
(43) Pub. Date: May 30, 2024

(54) PRINTING SYSTEM, DEVICE, AND CONTROL METHOD

(71) Applicant: CANON KABUSHIKI KAISHA, Tokyo (JP)

(72) Inventor: Dan Iwata, Saitama (JP)

(21) Appl. No.: 18/517,208

(22) Filed: Nov. 22, 2023

(30) Foreign Application Priority Data
Nov. 30, 2022 (JP) 2022-191979

(51) Int. Cl. G06Q 30/0283; G06K 15/00; G06K 15/10

(52) U.S. Cl. CPC G06Q 30/0283; G06K 15/102; G06K 15/407

(57) ABSTRACT

A printing system capable of dynamically changing a billing method for an ink usage amount for other than printing is provided. The printing system including a server and a device includes an accepting unit to accept printing instructions, a printing unit to perform printing by an inkjet printing method, a counting unit to count an ink amount used for printing for each user, a counting unit to count an ink amount used for other than printing, a counting unit to count the number of printed sheets for each user, a setting unit to set a billing method to one of a billing method based on the unit price for the number of printed sheets and a billing method based on the unit price for an ink amount, and a billing unit to perform a billing processing based on at least one of counting results obtained by the counting units.

### BACKGROUND OF THE INVENTION

### Field of the Invention

The present invention relates to a printing system, a device, and a control method, and particularly to a printing system including a server and a device, a device, and a control method.

### Description of the Related Art

Conventionally, a wide variety of methods for obtaining data to be printed by a printing device are known. For example, there are a method of obtaining the data to be printed from a host computer via a universal serial bus (USB) or a local area network (LAN), and a method of obtaining the data to be printed from a memory card via a memory card adapter provided in the printing device. In addition, there are also a method of obtaining data by scanning an image of an existing printed matter with a scanner provided in the printing device, and a method of obtaining the data to be printed from the Internet by using a service provided on a cloud.

Moreover, there is a printing service that adopts a meter-rate system and utilizes a cloud computing environment. For example, printing services such as a printing service, which uses a printing device installed in a public space such as a convenience store or a cafe, and a printing service, which is provided in the case that a personally-owned printing device is used for business purposes such as in the case of working from home, are provided in diverse environments. For example, an amount (a billing amount) charged for the printing service is determined according to a usage amount of the printing device such as the number of printed sheets, and is billed to a user on a monthly-basis via the cloud computing environment.

However, in the case of providing a printing service using an inkjet printer as the printing device, it is difficult to accurately and fairly perform a cost calculation and a billing processing according to the usage amount of the printing device. This is because there is ink consumption for purposes other than printing, which is used for maintenance such as head cleaning. Here, the head cleaning means cleaning of each nozzle of a print head of the inkjet printer. The inkjet printer performs printing by ejecting ink from each nozzle of the print head, but nozzles that have not been used for a while may become clogged and cannot be ejected. Therefore, in order to prevent nozzle clogging and maintain print quality, it is essential for the user to perform the head cleaning as appropriate, or for the inkjet printer to automatically perform the head cleaning at a certain timing. However, on the other hand, since the ink used in the head cleaning is discarded as waste ink, the problem is how to include the fee for such waste ink in the billing amount (a printing fee).

Japanese Laid-Open Patent Publication (kokai) No. 2010-184371 is a conventional technique regarding a billing processing that also takes a usage amount of the ink used for maintenance into account. In Japanese Laid-Open Patent Publication (kokai) No. 2010-184371, in addition to counting an ink usage amount used for printing for each job, it counts an ink usage amount used for purposes other than printing (an ink usage amount for other than printing), allocates the ink usage amount for other than printing as an ink usage amount used for printing according to attributes (print job, department, user), and calculates a billing amount. Furthermore, it is possible to switch to the method of allocating the ink usage amount for other than printing as the ink usage amount used for printing.

However, the conventional technique disclosed in Japanese Laid-Open Patent Publication (kokai) No. 2010-184371 has an issue of not being able to support the printing services that are provided in the diverse environments described above.

For example, in the case of providing a printing service in a public space such as a convenience store or a cafe, although a case may be considered in which the printing service is provided with a fixed charge per sheet printed, in this case, the method of calculating the billing amount disclosed in Japanese Laid-Open Patent Publication (kokai) No. 2010-184371 cannot be applied.

On the other hand, in the case of providing the printing service in working from home, it is desirable to charge companies based on an ink usage amount used for business purposes. Furthermore, in this case, it is also desirable to charge fairly for the ink usage amount for other than printing based on a usage record.

### SUMMARY OF THE INVENTION

The present invention provides a printing system, a device, and a control method that are capable of dynamically changing a billing method for an ink usage amount for other than printing to suit diverse environments.

Accordingly, the present invention provides a printing system that includes a server and a device, the printing system comprising an accepting unit configured to accept printing instructions from users, a printing unit configured to perform printing by an inkjet printing method, a first counting unit configured to count an ink amount used for printing performed by the printing unit for each user, a second counting unit configured to count an ink amount used for purposes other than printing performed by the printing unit, a third counting unit configured to count the number of printed sheets for each user, a billing method setting unit configured to set a billing method to one of a first method of billing based on a unit price for the number of printed sheets and a second method of billing based on a unit price for an ink amount, and a billing unit configured to perform a billing processing based on at least one counting result of counting results, which are obtained by the first counting unit, the second counting unit, and the third counting unit, respectively. The billing unit, in a case that the billing method set by the billing method setting unit is the first method, calculates a printing fee for an expense bearer according to the number of printed sheets for each user counted by the third counting unit, and in a case that the billing method set by the billing method setting unit is the second method, calculates the printing fee for the expense bearer according to a sum of the ink amount for each user counted by the first counting unit, and the ink amount used for purposes other than printing that has been counted by the second counting unit and has been allocated to the expense bearer.

Accordingly, the present invention provides device that is connected to a server, the device comprising an accepting unit configured to accept printing instructions from users, a printing unit configured to perform printing by an inkjet printing method, a first counting unit configured to count an ink amount used for printing performed by the printing unit for each user, a second counting unit configured to count an ink amount used for purposes other than printing performed by the printing unit, a third counting unit configured to count the number of printed sheets for each user, a count information notifying unit configured to notify the server of count information including counting results, which are obtained by the first counting unit, the second counting unit, and the third counting unit, respectively, a first obtaining unit configured to, in a case that a billing method is a first method of billing based on a unit price for the number of printed sheets, obtain a printing fee for each user according to the number of printed sheets for each user, which has been counted by the third counting unit and is included in the count information, from the server, and a second obtaining unit configured to, in a case that the billing method is a second method of billing based on a unit price for an ink amount, obtain a printing fee for each user according to a sum of the ink amount for each user counted by the first counting unit and the ink amount used for purposes other than printing that has been counted by the second counting unit and has been allocated for each user, from the server.

According to the present invention, it is possible to dynamically change the billing method for the ink usage amount for other than printing to suit the diverse environments.

Further features of the present invention will become apparent from the following description of exemplary embodiments with reference to the attached drawings.

### BRIEF DESCRIPTION OF THE DRAWINGS

FIG. 1 is a block diagram that shows an overall configuration of a printing system according to a first embodiment of the present invention.

FIG. 2 is a block diagram that shows a hardware configuration on a user environment side of the printing system shown in FIG. 1.

FIG. 3 is a block diagram that shows a hardware configuration on a cloud side of the printing system shown in FIG. 1.

FIG. 4 is a block diagram that shows a software configuration on the cloud side shown in FIG. 3.

FIG. 5 is a flowchart that shows an ink usage amount-for-other-than-printing counting processing according to the first embodiment of the present invention, which is executed in a printer shown in FIG. 2.

FIG. 6 is a sequence diagram that shows a print processing via a cloud according to the first embodiment of the present invention, which is executed in the printing system.

FIG. 7 is a sequence diagram that shows a print processing without via the cloud according to the first embodiment of the present invention, which is executed in the printing system.

FIG. 8 is a sequence diagram that shows a modification of the print processing without via the cloud shown in FIG. 7, which is executed in the printing system.

FIG. 9 is a sequence diagram that shows a printing fee confirmation processing according to the first embodiment of the present invention, which is executed in the printing system.

FIG. 10 is a flowchart that shows a printing fee calculation processing according to the first embodiment of the present invention, which is executed by a billing processing server in a step S903 of FIG. 9.

FIG. 11 is a sequence diagram that shows a print processing without via the cloud according to a second embodiment of the present invention, which is executed in the printing system.

FIG. 12 is a sequence diagram that shows a modification of the print processing without via the cloud shown in FIG. 11, which is executed in the printing system.

FIG. 13 is a sequence diagram that shows a print processing via the cloud according to the second embodiment of the present invention, which is executed in the printing system.

FIG. 14 is a flowchart that shows a printing fee confirmation processing according to the second embodiment of the present invention, which is executed by the billing processing server in the step S903 of FIG. 9.

### DESCRIPTION OF THE EMBODIMENTS

The present invention will now be described in detail below with reference to the accompanying drawings showing embodiments thereof.

Hereinafter, preferred embodiments of the present invention will be described in detail. It should be noted that the components described in the preferred embodiments are merely examples of the present invention, and the scope of the present invention is not limited thereto.

First, a first embodiment of the present invention will be described. Hereinafter, in the first embodiment, a case will be described in which a printing system 1 according to the present invention is applied to a service form that uses a printing device installed in a public space such as a convenience store or a cafe.

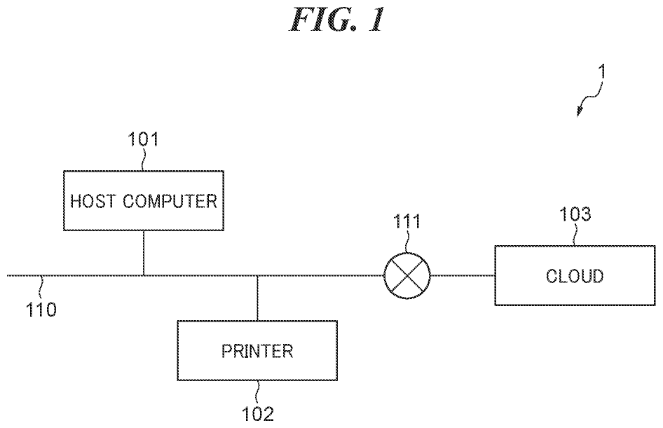

FIG. 1 is a block diagram that shows an overall configuration of the printing system 1.

As shown in FIG. 1, the printing system 1 includes, on a user environment side, a host computer 101 and a multifunction printer (hereinafter, referred to as a printer) 102, and the host computer 101 and the printer 102 are connected to each other via a local area network (hereinafter, referred to as a LAN) 110.

Further, the LAN 110 is connected via the Internet 111 to a cloud 103 side, which is configured by a plurality of servers (an example of information processing apparatuses).

That is, the user environment side including the host computer 101 and the printer 102 (an example of the printing device) and the cloud 103 side constitute the printing system 1 by being connected via the Internet 111.

It should be noted that, in the first embodiment, the case will be described in which the host computer 101 and the printer 102 exist as separate devices as the configuration (devices) on the user environment side, but they may be one device. Similarly, in the first embodiment, the case will be described in which the plurality of servers exists as the configuration (servers) on the cloud 103 side, but they may be one device.

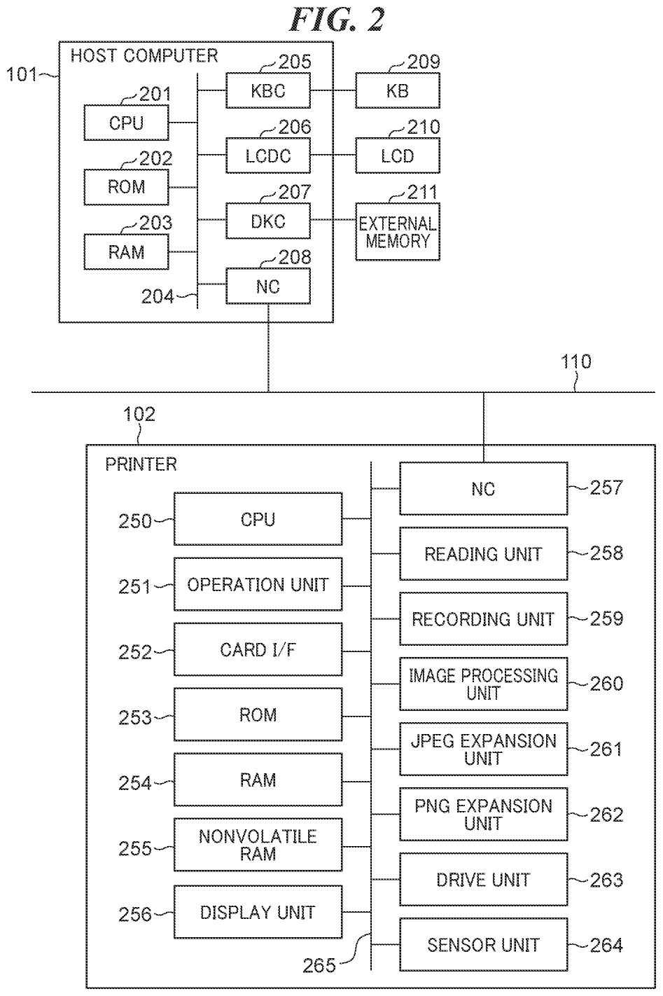

FIG. 2 is a block diagram that shows a hardware configuration on the user environment side of the printing system 1.

As described above, the printing system 1 includes the host computer 101 and the printer 102 on the user environment side.

As shown in FIG. 2, the host computer 101 includes respective devices, which are a central processing unit (CPU) 201, a read only memory (ROM) 202, a random access memory (RAM) 203, a keyboard controller (KBC) 205, a liquid crystal display controller (LCDC) 206, a disk controller (DKC) 207, and a network controller (NC) 208 that are connected to each other via a system bus 204.

Furthermore, the host computer 101 is connected to an external memory 211, a keyboard (KB) 209, and a liquid crystal display (LCD) 210.

The CPU 201 generally controls the respective devices connected to the system bus 204.

The DKC 207 is the disk controller, and controls access to the external memory 211 configured by a hard disk (HD) or the like that stores boot programs, various kinds of applications, a printer control command generation program (hereinafter, referred to as a printer driver), and the like.

The ROM 202 or the external memory 211 stores an operating system (OS) of the CPU 201, and programs such as application programs and the printer control command generation program. In addition to generally controlling the respective devices, the CPU 201 executes a processing of creating document data containing a mixture of figures, images, characters, tables, etc. (hereinafter, referred to as a document data creating processing) and a processing of generating print job data of the document data (hereinafter, referred to as a print job data generating processing) based on these programs.

The ROM 202 or the external memory 211 further stores font data used when performing the print job data generating processing of the document data, and various kinds of data, etc. that are used when performing the document data creating processing, the print job data generating processing, and the like.

The RAM 203 functions as a main memory, a working area, etc. of the CPU 201. The KBC 205 is the keyboard controller that controls key input from the KB 209 and a pointing device (not shown). The LCDC 206 is the liquid crystal display controller (an LCD controller) that controls the display of the LCD 210, which is a liquid crystal display unit.

The NC 208 is the network controller that is connected to the printer 102 and a cloud 103 (not shown) via the LAN 110 and the Internet 111, and executes a communication control processing with the printer 102 and the cloud 103.

It should be noted that the CPU 201 opens various registered windows on the LCD 210 based on commands instructed by a mouse cursor (not shown), etc., and executes various data processes.

When a user executes printing, the CPU 201 opens a window related to print settings on the LCD 210, and allows the user to perform the print settings with respect to the printer 102.

The printer 102 includes a CPU 250, an operation unit 251, a card interface (a card I/F) 252, a ROM 253, a RAM 254, a nonvolatile RAM 255, a display unit 256, an NC 257, a reading unit 258, and a recording unit 259. Further, the printer 102 includes an image processing unit 260, a JPEG expansion unit 261, a PNG expansion unit 262, a drive unit 263, and a sensor unit 264. Respective devices (the CPU 250, the operation unit 251, the card I/F 252, the ROM 253, the RAM 254, the nonvolatile RAM 255, the display unit 256, the NC 257, the reading unit 258, the recording unit 259, the image processing unit 260, the JPEG expansion unit 261, the PNG expansion unit 262, the drive unit 263, and the sensor unit 264) are connected to each other via a system bus 265.

The card I/F 252 is the card interface that controls access to a memory card (not shown).

The ROM 253 stores a control command program for the printer 102.

The CPU 250 executes the control command program stored in the ROM 253 and controls various functions provided in the printer 102. For example, the CPU 250 displays a menu of functions that the printer 102 provides to the user on the display unit 256, accepts operations from the user via the operation unit 251, and controls the reading unit 258 and the recording unit 259 to provide the user with a copy function.

The NC 257 is a network controller that is connected to the host computer 101 and the cloud 103 (not shown) via a network, and executes a communication control processing with the host computer 101 and the cloud 103. The printer 102 is able to use the NC 257 to hold image data and job data, which are received from other devices, in the RAM 254.

In addition, the printer 102 is able to use the card I/F 252 to read out image data from the memory card connected to the printer 102 by the user and store it in the RAM 254.

The JPEG expansion unit 261 is able to read image data compressed in the JPEG (Joint Photographic Experts Group) format from the RAM 254, decode it into an RGB dot-sequential image, and write it to the RAM 254.

Similarly, the PNG expansion unit 262 is able to read image data compressed in the PNG (Portable Network Graphics) format from the RAM 254, decode it, and write it to the RAM 254.

The image processing unit 260 is a functional unit that performs various kinds of image processing (image processes) with respect to image data outputted through an expansion processing compatible with various kinds of image data formats. For example, the image processing unit 260 performs the image processes such as image analysis, calculation of conversion characteristics, conversion from luminance signals (RGB) to density signals (CMYK), scaling, gamma conversion, and error diffusion. Further, the image data subjected to these image processes is stored in the RAM 254.

It should be noted that the expansion processing compatible with various kinds of image data formats means a processing, in which the image data compressed in the JPEG format or the PNG format stored in RAM 254 is decoded by the corresponding JPEG expansion unit 261 or the corresponding PNG expansion unit 262. In addition, the expansion processing compatible with various kinds of image data formats also includes a processing, in which the CPU 250 decodes image data compressed in one of image data formats other than the JPEG format and the PNG format based on the program stored in the ROM 253.

The recording unit 259 includes an inkjet print head (not shown), a general-purpose integrated circuit (a general-purpose IC) (not shown), etc., and when the data stored in the RAM 254 reaches a predetermined amount of data, the recording unit 259 executes a recording operation of the data. Specifically, the recording unit 259 reads out the image data stored in the RAM 254 under the control of the CPU 250, and records and outputs the image data as a hard copy in cooperation with the drive unit 263 and the sensor unit 264.

Further, the CPU 250 controls the drive unit 263 and the sensor unit 264 in cooperation with each other to execute a first ink usage amount counting processing, a number-of-printed-sheets counting processing, and a second ink usage amount counting processing. The first ink usage amount counting processing is a processing that counts an ink amount used for printing by the printer 102, and the number-of-printed-sheets counting processing is a processing that counts the number of printed sheets used for printing by the printer 102. Further, the second ink usage amount counting processing is a processing that counts an ink amount used for purposes other than printing. Count information obtained through these counting processing (the first ink usage amount counting processing, the number-of-printed-sheets counting processing, and the second ink usage amount counting processing) is stored in the nonvolatile RAM 255. It should be noted that, in the first embodiment, the ink usage amount is calculated by the CPU 250 based on the result of counting electrical signals for the drive unit 263 to eject ink droplets from nozzles of the print head of the recording unit 259.

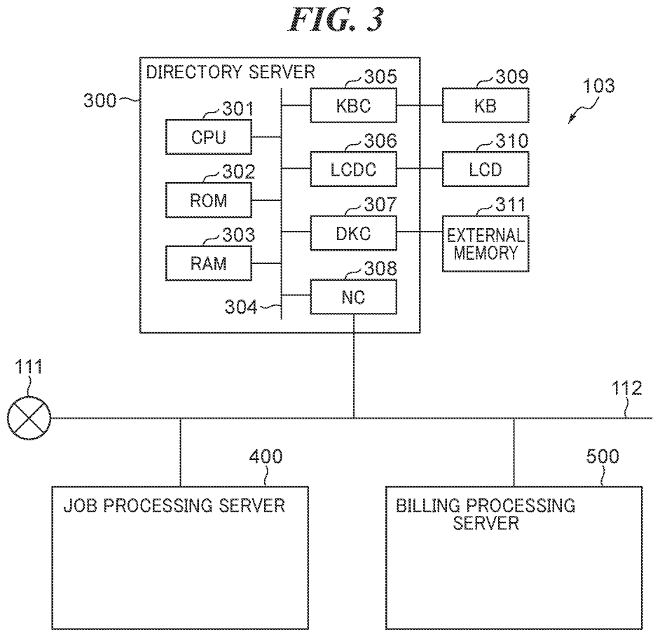

FIG. 3 is a block diagram that shows a hardware configuration on the cloud 103 side of the printing system 1.

As shown in FIG. 3, the hardware on the cloud 103 side of the printing system 1 includes a directory server 300, a job processing server 400, and a billing processing server 500 (an example of a billing unit) that are connected to each other via a network 112.

The directory server 300 has a function of accepting job data from the host computer 101, and the job processing server 400 has a function of generating printing data corresponding to print settings described in the job data. In addition, the billing processing server 500 has a function of performing a billing processing in accordance with a print processing executed by the printer 102.

As shown in FIG. 3, the directory server 300 includes respective devices, which are a CPU 301, a ROM 302, a RAM 303, a KBC 305, an LCDC 306, a DKC 307, and an NC 308 that are connected to each other via a system bus 304.

Furthermore, the directory server 300 is connected to an external memory 311, a keyboard (KB) 309, and an LCD 310.

The CPU 301 generally controls the respective devices connected to the system bus 304.

The DKC 307 is a disk controller, and controls access to the external memory 311 configured by a hard disk (HD) or the like that stores boot programs, various kinds of applications, a printer control command generation program (hereinafter, referred to as a printer driver), and the like.

The ROM 302 or the external memory 311 stores an operating system (OS) of the CPU 301, a job acceptance program, and the like.

In addition to generally controlling the respective devices, the CPU 301 executes a processing of allocating received job data to the job processing server 400 (hereinafter, referred to as a job allocating processing) based on the job acceptance program and the like.

The ROM 302 or the external memory 311 further stores various kinds of data used when performing the job allocating processing and the like.

The RAM 303 functions as a main memory, a working area, etc. of the CPU 301. The KBC 305 is a keyboard controller that controls key input from the KB 309 and a pointing device (not shown). The LCDC 306 is an LCD controller that controls the display of the LCD 310, which is a liquid crystal display unit.

The DKC 307 is the disk controller that controls the access to the external memory 311 configured by the hard disk (HD) or the like that stores the boot programs, the various kinds of applications, user files, edit files, etc.

The NC 308 is a network controller that is connected to the job processing server 400 and the billing processing server 500 via the network 112, and executes a communication control processing with the job processing server 400 and the billing processing server 500.

The hardware configurations of the job processing server 400 and the billing processing server 500 are almost the same as the hardware configuration of the directory server 300, except for the points described below. Therefore, hereinafter, numbering in the 400s will be used for the hardware configuration of the job processing server 400. For example, as a hardware component corresponding to the CPU 301 of the directory server 300, the job processing server 400 includes a CPU 401. Similarly, numbering in the 500s will be used for the hardware configuration of the billing processing server 500.

The difference between the hardware configuration of the job processing server 400 and the hardware configuration of the directory server 300 is that, in the job processing server 400, a job processing program is stored in a ROM 402 or an external memory 411. The job processing program receives the settings specified by the job and the document to be printed from the directory server 300, and generates printing data in a format that can be processed by the target printer 102 (for example, sheet size A4 and JPEG image format). Then, the printing data is transmitted to the printer 102.

In addition, the difference between the hardware configuration of the job processing server 400 and the hardware configuration of the billing processing server 500 is that, in the billing processing server 500, a billing processing program is stored in a ROM 502 or an external memory 511. The billing processing program enables a CPU 501 of the billing processing server 500 to function as the billing unit and a billing method setting unit of the present invention. The billing processing program supports two billing methods, that is, a billing method of determining a printing fee based on a unit price for the number of printed sheets (hereinafter, referred to as a billing method based on the unit price for the number of printed sheets) and a billing method of determining a printing fee based on a unit price for the ink usage amount (hereinafter, referred to as a billing method based on the unit price for the ink usage amount). Before providing a printing service in the printing system 1, a system administrator sets one of the two billing methods in advance in the billing processing server 500 depending on the content of the printing service. The set billing method is stored in the external memory 511 of the billing processing server 500. In the case of the billing method based on the unit price for the number of printed sheets, the printing fee per printed sheet is set by also taking the fee for an ink usage amount for other than printing into consideration in advance. On the other hand, the billing method based on the unit price for the ink usage amount assumes that billing (charging) is performed based on an ink usage amount, which is the sum of the ink usage amount for printing and the ink usage amount for other than printing. Furthermore, the billing processing program manages information on users who use the printing system 1 or departments, to which they belong, in the ROM 502, and calculates the printing fees for expense bearers that are set for the users or the departments.

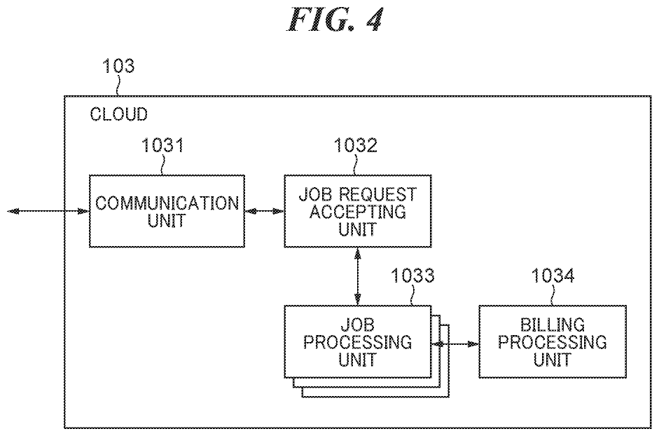

FIG. 4 is a block diagram that shows a software configuration on the cloud side of the printing system 1.

It should be noted that, in FIG. 4, the entire software configuration realized by three servers, that is, the directory server 300, the job processing server 400, and the billing processing server 500 that are shown in FIG. 3, is shown as one.

As shown in FIG. 4, the cloud 103 includes a communication unit 1031, a job request accepting unit 1032, a plurality of job processing units 1033, and a billing processing unit 1034 as software modules.

The communication unit 1031 receives data from the host computer 101 and the printer 102 and transmits data from the cloud 103.

When the job request accepting unit 1032 accepts job data from the communication unit 1031, the job request accepting unit 1032 analyzes the processing content of the job data and then transmits the job data to the corresponding job processing unit 1033.

In addition, when the job request accepting unit 1032 receives a printing completion notification of the printer 102 from the communication unit 1031, the job request accepting unit 1032 transmits the printing completion notification to the corresponding job processing unit 1033.

When each of the plurality of job processing units 1033 receives the job data from the job request accepting unit 1032, it processes the received job data, generates printing data, and transmits the printing data to the communication unit 1031.

When each of the plurality of job processing units 1033 receives the printing completion notification from the job request accepting unit 1032, it transmits a completion notification, which notifies that the process handled by the job processing unit 1033 that received the printing completion notification has been completed, to the billing processing unit 1034.

Upon receiving the completion notification from the job processing unit 1033 that received the printing completion notification, the billing processing unit 1034 stores the received information.

It should be noted that the printing completion notification is not limited to a notification of the completion of printing executed by the host computer 101 and the printer 102 via the cloud 103. For example, the completion of printing executed by the host computer 101 and the printer 102 without via the cloud 103, or the completion of printing executed only by the printer 102, is also notified as the printing completion notification.

In other words, the information on the printing completion notification including printing executed without via the cloud 103 is passed to the billing processing unit 1034 to perform the billing processing. That is, the job processing unit 1033 that processes the printing completion notification of the printing executed without via the cloud 103 also exists.

In addition, in each printing, information that allows identification of the expense bearer is also notified to the cloud 103 at the time of notification of printing completion.

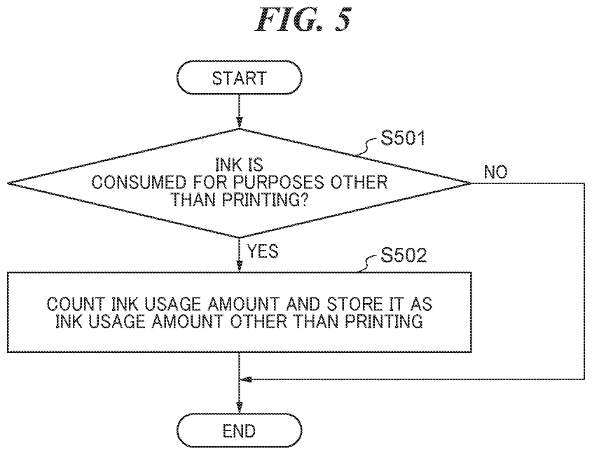

FIG. 5 is a flowchart that shows an ink usage amount-for-other-than-printing counting processing according to the first embodiment of the present invention, which is executed in the printer 102.

In order to maintain print quality, the printer 102 performs head cleaning that eliminates nozzle clogging by ejecting ink from each nozzle of the print head of the recording unit 259. The head cleaning is executed when the user instructs the printer 102 to perform head cleaning from the operation unit 251 of the printer 102 or an application on the host computer 101, or at a timing preset in the printer 102. Here, “the ink usage amount for other than printing” is, for example, an ink usage amount during maintenance such as the head cleaning.

When the maintenance is started on the printer 102, the CPU 250 of the printer 102 reads out the control command program from the ROM 253 and starts the ink usage amount-for-other-than-printing counting processing.

First, in a step S501, the CPU 250 determines whether or not the ink is used (consumed) for purposes other than printing.

In the case that the ink is used for purposes other than printing (YES in the step S501), the ink usage amount-for-other-than-printing counting processing proceeds to a step S502.

In the step S502, the CPU 250 (functioning as a second counting unit) counts the ink usage amount used for purposes other than printing, and stores it in the nonvolatile RAM 255 (a first holding unit) of the printer 102 as the count information indicating the ink usage amount for other than printing. After that, the CPU 250 ends the ink usage amount-for-other-than-printing counting processing.

On the other hand, in the case that the ink is not used for purposes other than printing (NO in the step S501), the CPU 250 ends the ink usage amount-for-other-than-printing counting processing.

It should be noted that the count information stored in the nonvolatile RAM 255 is added and stored in the case that there is a stored value, and is reset when notification of the count information to the cloud 103 is completed. After that, the CPU 250 ends the ink usage amount-for-other-than-printing counting processing of FIG. 5.

It should be noted that in the first embodiment, when the printer 102 receives a count information reception completion notification from the cloud 103, the printer 102 determines that the notification of the count information to the cloud 103 has been completed and performs the above-mentioned reset, but the present invention is not limited thereto. For example, when the printer 102 transmits the printing completion notification, which will be described below and includes the count information, to the cloud 103, the printer 102 may determine that the notification of the count information to the cloud 103 has been completed and may perform the above-mentioned reset.

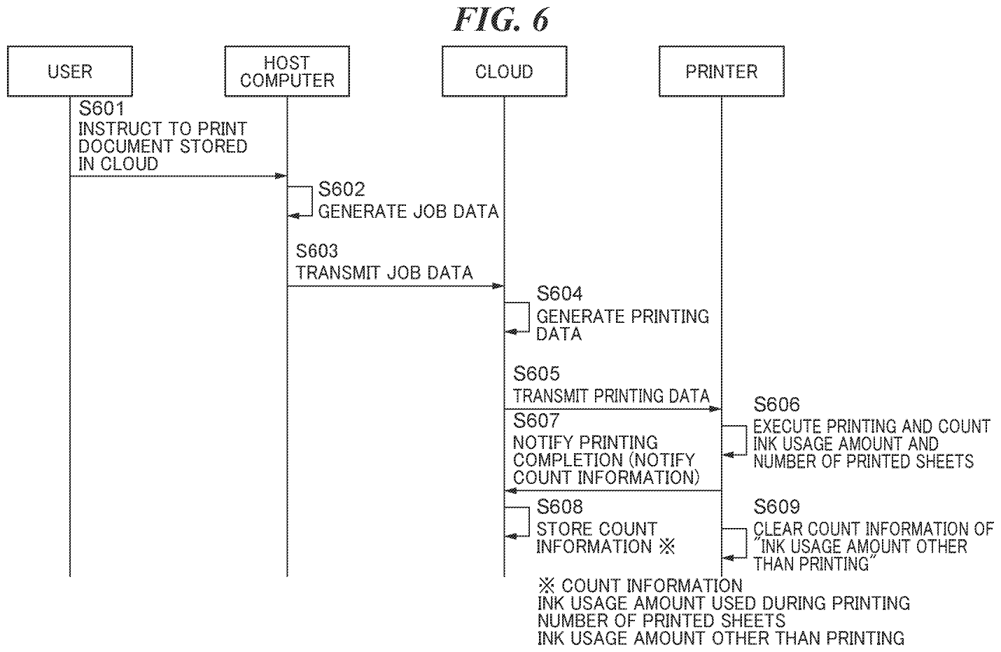

FIG. 6 is a sequence diagram that shows a print processing via the cloud 103 according to the first embodiment of the present invention, which is executed in the printing system 1.

It should be noted that execution entities of processing shown in FIGS. 6 to 14, which will be described below and is executed in the printing system 1, are the CPU 201 of the host computer 101, the CPU 301, the CPU 401, and the CPU 501 of various servers constituting the cloud 103, and the CPU 250 of the printer 102. However, in order to simplify the description, the execution entities are abbreviated as the host computer 101, the cloud 103, and the printer 102, respectively.

Here, “the print processing via the cloud 103” is a print processing executed by the printing system 1 when the user uses the host computer 101 to instruct the cloud 103 to print a document that has been stored (saved) in the cloud 103 in advance.

In the first embodiment, the user has previously registered information regarding a storage service of the cloud 103 that the user is using, in the host computer 101. Therefore, the host computer 101 communicates with the cloud 103 based on this registered information to display a file name and a preview of the document owned by the user in accordance with the user's instruction.

The print processing via the cloud 103 starts when the user, after logging into the host computer 101, issues a printing instruction of the document stored (saved) in the cloud 103 by using an operation unit (an accepting unit) such as the KB 209.

In a step S601, when the host computer 101 (the device) functioning as a printing unit detects the printing instruction of the document stored in the cloud 103, which has been issued by the user, the print processing via the cloud 103 proceeds to a step S602 so that the printer 102 performs printing via the cloud 103.

In the step S602, the host computer 101 generates job data, which describes print settings, a uniform resource locator (URL) of the document, an access token for referencing the document, etc. that are included in the printing instruction detected in the step S601.

In a step S603, the host computer 101 transmits the job data generated in the step S602 to the cloud 103.

In a step S604, upon receiving the job data transmitted from the host computer 101 in the step S603, the cloud 103 first obtains the document to be printed by using the URL and the access token that have been described in the job data. Next, the cloud 103 generates printing data based on the obtained document and the print settings described in the job data.

In a step S605, the cloud 103 transmits the printing data generated in the step S604 to the printer 102.

In a step S606, upon receiving the printing data transmitted from the cloud 103 in the step S605, the printer 102 (functioning not only as a first counting unit but also as a third counting unit) starts printing of the printing data and starts counting of the ink usage amount and the number of printed sheets. Here, to be more precise, the number of printed sheets according to the first embodiment refers to the number of printed sides. For example, in the case of performing double-sided printing, it is possible to perform printing on two sides, the front side and the back side, for one output sheet. In this case, the printer 102 counts up 2 for one output sheet. Even with double-sided printing settings, in the case of performing printing only on the front side, the printer 102 counts up 1 for one output sheet. Furthermore, also in the case of executing a so-called N in 1 printing function in which a plurality of pages are allocated and printed on one output sheet, the printer 102 counts up the number of sides of output sheets used for printing.

In a step S607, when the printing started in the step S606 is completed, the printer 102 ends the counting that is also started in the step S606. Next, the printer 102 (a count information notifying unit) issues the printing completion notification, which includes a user ID of the user logging into the host computer 101 and the count information, to the cloud 103. The count information here refers to the result of the counting completed in the step S607 (the ink usage amount and the number of printed sheets when the printing is executed based on the job data generated in the step S602), and the ink usage amount for other than printing, which is stored in the nonvolatile RAM 255 through the ink usage amount-for-other-than-printing counting processing of FIG. 5. In this way, the ink usage amount and the number of printed sheets when the printing is executed based on the job data are associated with the user ID and are transmitted to the cloud 103 for each user.

In a step S608, upon receiving the printing completion notification transmitted from the printer 102 in the step S607, the cloud 103 stores the count information included in the printing completion notification in order to calculate the fee when performing the billing processing. Thereafter, the cloud 103 transmits the count information reception completion notification (not shown in FIG. 6) to the printer 102.

In a step S609, upon receiving the count information reception completion notification transmitted from the cloud 103 in the step S608, the printer 102 resets (clears) the count information of the ink usage amount for other than printing that has been stored. Thereafter, the print processing via the cloud 103 of FIG. 6 is ended.

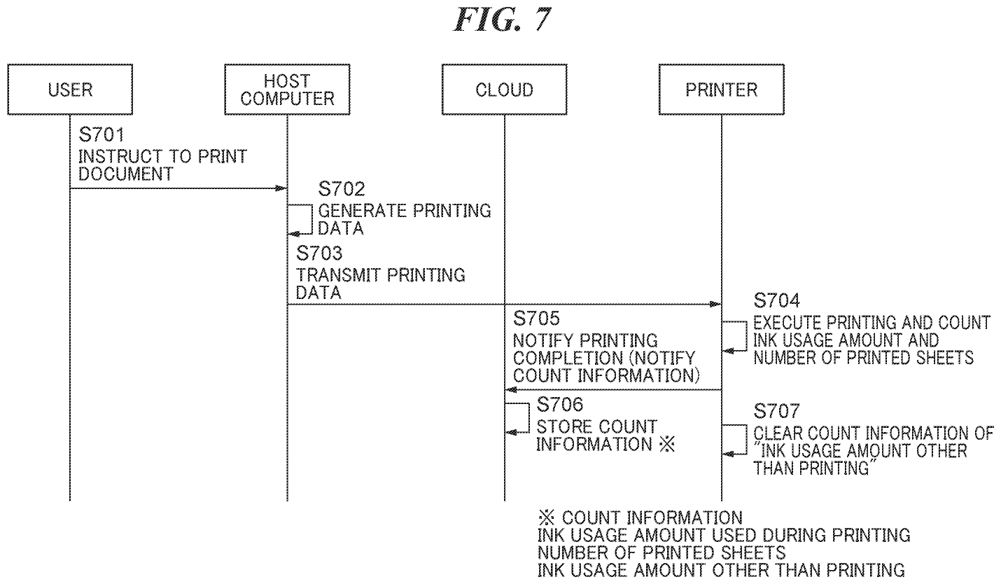

FIG. 7 is a sequence diagram that shows a print processing without via the cloud 103 according to the first embodiment of the present invention, which is executed in the printing system 1. Here, “the print processing without via the cloud 103” shown in FIG. 7 is a processing in which a document that the user has previously saved in the host computer 101 is printed by the printer 102 without via the cloud 103.

The print processing without via the cloud 103 shown in FIG. 7 starts when the user, after logging into the host computer 101, issues a printing instruction of the document stored (saved) in the host computer 101 by using the operation unit (the accepting unit) such as the KB 209.

In a step S701, when the host computer 101 (the device) functioning as the printing unit detects the printing instruction of the document stored in the host computer 101, which has been issued by the user, the print processing without via the cloud 103 proceeds to a step S702 so that the printer 102 performs printing without via the cloud 103.

In the step S702, the host computer 101 generates printing data based on print settings included in the printing instruction detected in the step S701, and the document.

In a step S703, the host computer 101 transmits the printing data generated in the step S702 to the printer 102.

In a step S704, upon receiving the printing data transmitted from the host computer 101 in the step S702, the printer 102 (functioning not only as the first counting unit but also as the third counting unit) starts printing of the printing data and starts counting of the ink usage amount and the number of printed sheets.

In a step S705, when the printing started in the step S704 is completed, the printer 102 ends the counting that is also started in the step S704. Next, the printer 102 (the count information notifying unit) issues the printing completion notification, which includes a user ID of the user logging into the host computer 101 and the count information, to the cloud 103. The count information here refers to the result of the counting completed in the step S705 (the ink usage amount and the number of printed sheets when the printing is executed based on the printing data generated in the step S702), and the ink usage amount for other than printing, which is stored in the nonvolatile RAM 255 through the ink usage amount-for-other-than-printing counting processing of FIG. 5. In this way, the ink usage amount and the number of printed sheets when the printing is executed based on the printing data are associated with the user ID and are transmitted to the cloud 103 for each user.

In a step S706, upon receiving the printing completion notification transmitted from the printer 102 in the step S705, the cloud 103 stores the count information included in the printing completion notification in order to calculate the fee when performing the billing processing. Thereafter, the cloud 103 transmits the count information reception completion notification (not shown in FIG. 7) to the printer 102.

In a step S707, upon receiving the count information reception completion notification transmitted from the cloud 103 in the step S706, the printer 102 resets (clears) the count information of the ink usage amount for other than printing that has been stored. Thereafter, the print processing without via the cloud 103 of FIG. 7 is ended.

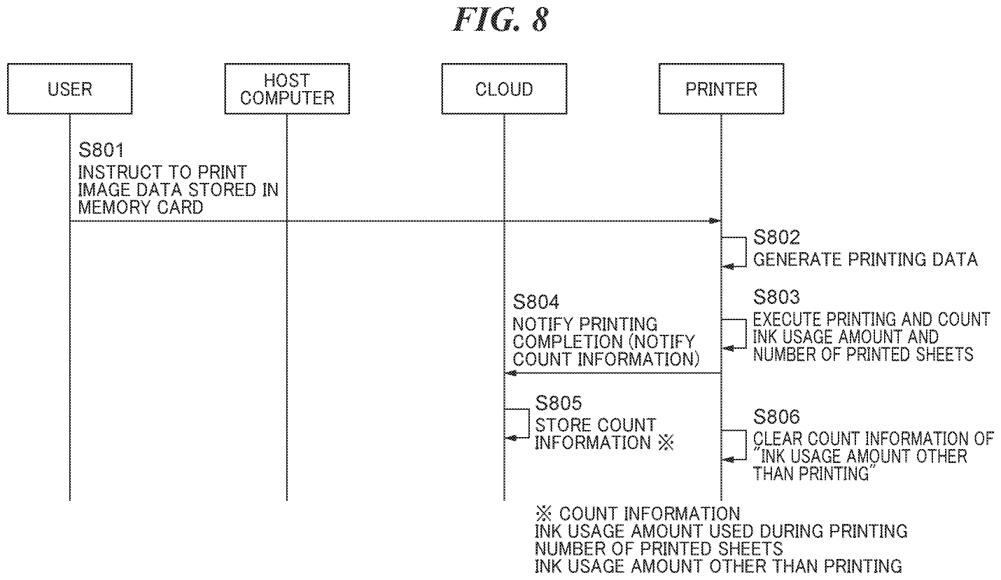

FIG. 8 is a sequence diagram that shows a modification of the print processing without via the cloud 103 shown in FIG. 7, which is executed in the printing system 1. “The print processing without via the cloud 103” in this modification is a print processing in which the user connects the memory card to the printer 102 and image data read from the memory card is printed by the printer 102 without via the cloud 103.

The print processing without via the cloud 103 in this modification starts when the user, after logging into the printer 102, issues a printing instruction of the image data stored in the memory card connected to the printer 102 by using the operation unit 251 (the accepting unit).

In a step S801, when the printer 102 (the device) functioning as the printing unit detects the printing instruction of the image data stored in the memory card, which has been issued by the user, the print processing without via the cloud 103 in this modification proceeds to a step S802 so that the printer 102 performs printing without via the cloud 103.

In the step S802, the printer 102 reads out the image data specified by the printing instruction detected in the step S801 from the memory card, and generates printing data based on the image data that has been read out and print settings included in the printing instruction detected in the step S801.

In a step S803, the printer 102 (functioning not only as the first counting unit but also as the third counting unit) starts printing of the printing data generated in the step S802 and starts counting of the ink usage amount and the number of printed sheets.

In a step S804, when the printing started in the step S803 is completed, the printer 102 ends the counting that is also started in the step S803. Next, the printer 102 (the count information notifying unit) issues the printing completion notification, which includes a user ID of the user logging into the printer 102 and the count information, to the cloud 103. The count information here refers to the result of the counting completed in the step S804 (the ink usage amount and the number of printed sheets when the printing is executed based on the printing data generated in the step S802), and the ink usage amount for other than printing, which is stored in the nonvolatile RAM 255 through the ink usage amount-for-other-than-printing counting processing of FIG. 5. In this way, the ink usage amount and the number of printed sheets when the printing is executed based on the printing data are associated with the user ID and are transmitted to the cloud 103 for each user.

In a step S805, upon receiving the printing completion notification transmitted from the printer 102 in the step S804, the cloud 103 stores the count information included in the printing completion notification in order to calculate the fee when performing the billing processing. Thereafter, the cloud 103 transmits the count information reception completion notification (not shown in FIG. 8) to the printer 102.

In a step S806, upon receiving the count information reception completion notification transmitted from the cloud 103 in the step S805, the printer 102 resets (clears) the count information of the ink usage amount for other than printing that has been stored. Thereafter, the print processing without via the cloud 103 of FIG. 8 is ended.

It should be noted that although FIG. 8 shows the sequence for printing the image data recorded on the memory card as a case where printing is executed by the printer 102 alone, the case where printing is executed by the printer 102 alone is not limited to this. In other words, it goes without saying that the print processing without via the cloud 103 of FIG. 8 can be applied to general printing processes such as copying.

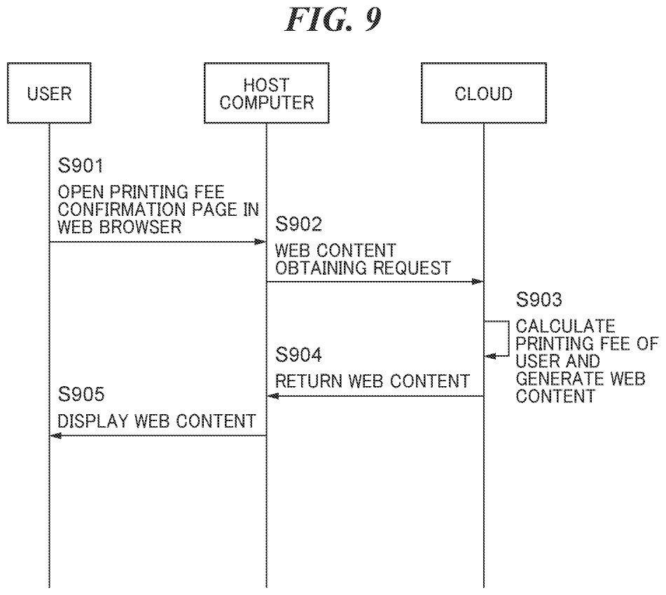

FIG. 9 is a sequence diagram that shows a printing fee confirmation processing according to the first embodiment of the present invention, which is executed in the printing system 1. In the first embodiment, the user uses a web browser of the host computer 101 to confirm the printing fee for the printing service.

The printing fee confirmation processing starts when the user accesses a URL of a printing fee confirmation page by using the web browser of the host computer 101 by using the operation unit (the accepting unit) such as the KB 209 and then logs into the printing service to open the printing fee confirmation page.

In a step S901, when the host computer 101 (functioning not only as a first obtaining unit but also as a second obtaining unit) detects that the user has opened the printing fee confirmation page of the web browser, the printing fee confirmation processing proceeds to a step S902.

In a step S902, the host computer 101 issues (transmits) a web content obtaining request to the cloud 103 (the billing processing server 500).

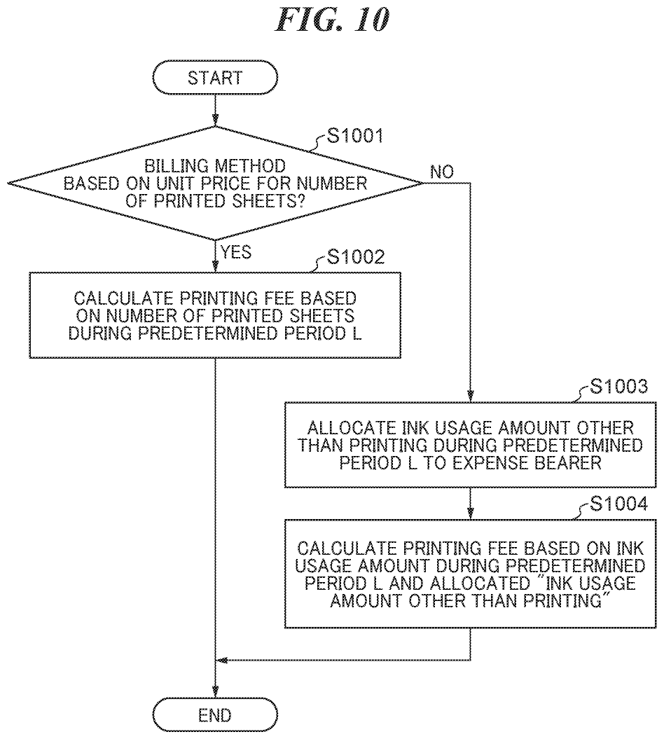

In a step S903, upon receiving the web content obtaining request transmitted from the host computer 101 in the step S902, the cloud 103 first performs a printing fee calculation processing, the details of which will be described below with reference to FIG. 10, to calculate the printing fee of the user. Next, the cloud 103 generates a web content that includes the printing fee of the user calculated.

In a step S904, the cloud 103 returns the web content generated in the step S903 to the host computer 101 as a response to the web content obtaining request.

In a step S905, upon receiving the web content returned from the cloud 103 in the step S904, the host computer 101 displays the web content on the web browser, and ends the printing fee confirmation processing. As a result, the user is able to confirm the printing fee via the web browser of the host computer 101.

FIG. 9 shows an example in which the web browser running on the host computer 101 is used as a means for the user to confirm the printing fee. However, the means to confirm the printing fee can be realized in various forms. For example, the printer 102 may be equipped with a web browser so that the user can confirm the printing fee on the display unit 256 included in the printer 102. Alternatively, instead of in the form of the web content, the cloud 103 may notify the host computer 101 or the printer 102 of the printing fee calculated through the printing fee calculation processing, and the host computer 101 or the printer 102 may display the notification result to the user. As described above, the means for the user to confirm the printing fee can be realized in various forms. Alternatively, the host computer 101 may periodically obtain the printing fee from the cloud 103 and hold the printing fee in the RAM 203 so that it can be read out by the user.

FIG. 10 is a flowchart that shows the printing fee calculation processing according to the first embodiment of the present invention, which is executed by the cloud 103 (the billing processing server 500) in the step S903 of FIG. 9.

Here, the printing fee is a usage fee for the printing system 1 of the expense bearer during a predetermined period L. In the first embodiment, the predetermined period L is one month, and the printing fee is determined on the 25th of every month. The printing fee calculated in the middle of the predetermined period L is the provisional fee at that time.

The printing fee calculation processing is executed in the billing processing server 500, which is one of the servers constituting the cloud 103, by the CPU 501 reading out the billing processing program stored in the ROM 502 or the external memory 511.

In a step S1001, the CPU 501 confirms the billing method set in advance by the system administrator, and determines whether or not the billing method is the billing method based on the unit price for the number of printed sheets. In the case that the billing method is the billing method based on the unit price for the number of printed sheets (YES in the step S1001), the printing fee calculation processing proceeds to a step S1002. On the other hand, in the case that the billing method is not the billing method based on the unit price for the number of printed sheets (NO in the step S1001), that is, in the case that the billing method is the billing method based on the unit price for the ink usage amount, the printing fee calculation processing proceeds to a step S1003.

In the step S1002, the CPU 501 calculates the printing fee of the expense bearer of the user logging into the printing service in the printing fee confirmation processing of FIG. 9 based on the number of printed sheets for each user during the predetermined period L. For example, in the case that the unit price for the number of printed sheets is X and the number of printed sheets is N, X×N will be calculated as the printing fee. Thereafter, the CPU 501 ends the printing fee calculation processing. In this case, the ink usage amount for other than printing is calculated in advance, and the fee for the ink usage amount for other than printing is included in the unit price for the number of printed sheets X as a fixed fee.

In the step S1003, the CPU 501 allocates the ink usage amount for other than printing during the predetermined period L to the expense bearer. For example, the CPU 501 allocates the ink usage amount for other than printing to the expense bearer according to a ratio of the ink usage amount for printing for each user during the predetermined period L.

In a step S1004, the CPU 501 calculates the printing fee of the expense bearer based on the ink usage amount for printing for the expense bearer during the predetermined period L and the ink usage amount for other than printing that has been allocated in the step S1003. For example, in the case that the unit price for the ink usage amount is Y, the ink usage amount for printing is M1, and the ink usage amount for other than printing that has been allocated in the step S1003 is M2, Y×(M1+M2) will be calculated as the printing fee. Thereafter, the CPU 501 ends the printing fee calculation processing.

It should be noted that in the first embodiment, in the step S1003, although the ink usage amount for other than printing is allocated to the expense bearer according to the ratio of the ink usage amount for printing for each user, the method of allocating the ink usage amount for other than printing is not limited to this. For example, the ink usage amount for other than printing may be allocated to the expense bearer according to the number of printed sheets for each user. Furthermore, the method of allocating the ink usage amount for other than printing may be initialized in advance, or may be configured to be set in advance by the system administrator on the billing processing server 500.

It should be noted that although FIG. 9 shows an example in which the printing fee is calculated in the step S903, the printing fee confirmation processing shown in FIG. 10 may be automatically executed during a period of time when the processing load on the cloud 103 is light, and the printing fee may be stored in the cloud 103.

As described above, according to the first embodiment, in the printing system 1, the printer 102 counts the number of printed sheets, the ink usage amount used for printing, and the ink usage amount for other than printing regardless of the billing method, and notifies the cloud 103 of the result of the counting. The cloud 103 is able to support both billing based on the unit price for the number of printed sheets and billing based on the unit price for the ink usage amount, according to the billing method set in advance by the system administrator. As a result, in the printing system 1, it is possible to change to the billing method also including the ink usage amount for other than printing without changing the configuration of the printing system 1.

Next, a second embodiment of the present invention will be described. Hereinafter, in the second embodiment, a service form, in which only specific expense bearers are set as billing targets, is applied to the printing system 1 that has been described with the first embodiment. For example, in the case that an individual works from home and uses ink purchased by the individual for both business and personal purposes, only the printing fee for the ink used for the business purpose is billed to the company that is the expense bearer as a billing target of the printing system 1, and the printing fee for the ink used for the personal purpose is excluded from the billing target.

In the first embodiment, the printer 102 also transmits the printing completion notification to the cloud 103 with respect to printing executed by the printer 102 without via the cloud 103, for example, with respect to printing executed by the host computer 101 and the printer 102, or with respect to printing executed only by the printer 102. In addition, since the calculation of the printing fee is performed in the cloud 103, the printing completion notification includes the count information (the number of printed sheets, the ink usage amount for printing, and the ink usage amount for other than printing).

Therefore, even in the case that the printer 102 executes printing without via the cloud 103, in the first embodiment, it is necessary to be able to communicate with the cloud 103. In addition, in the first embodiment, since the count information is notified to the cloud 103 for each job even with respect to printing for personal purpose other than the business purpose, this is also undesirable from the viewpoint of personal information protection.

Therefore, in the second embodiment, the CPU 250 (a billing target determining unit) of the printer 102 determines whether or not the printing data being a printing target of the printer 102 (i.e., the printing data to be printed by the printer 102) is printing data that is not subject to billing (i.e., printing data that is not a billing target). As a result of the determination, in the case that the printing data being the printing target of the printer 102 is the printing data being not the billing target, the count information of the job (the number of printed sheets and the ink usage amount for printing that are not subject to billing, i.e., the number of printed sheets and the ink usage amount for printing that are not billing targets) is stored as count information that is not subject to billing (i.e., count information that is not a billing target). It should be noted that when performing this storage, in the case that there is a value already stored in the printer 102 as the count information that is not subject to billing, it is added to that value and stored, and later reset when the notification of the count information to the cloud 103 is completed.

In the second embodiment, information about whether or not it is subject to billing (i.e., information about whether or not it is a billing target) is embedded in the printing data. Specifically, in the case of printing via the cloud 103, information indicating that it is subject to billing (i.e., information indicating that it is a billing target) is embedded in the printing data transmitted from the cloud 103 to the printer 102. In addition, in the case of printing without via the cloud 103, the information indicating that it is subject to billing (i.e., the information indicating that it is a billing target) is not embedded in the printing data transmitted to the printer 102. In the case that the information indicating that it is a billing target is embedded in the transmitted printing data, the CPU 250 (the billing target determining unit) of the printer 102 determines that the transmitted printing data is printing data that is subject to billing (i.e., printing data that is a billing target). On the other hand, in the case that the information indicating that it is a billing target is not embedded in the transmitted printing data, the CPU 250 (the billing target determining unit) of the printer 102 determines that the transmitted printing data is the printing data that is not subject to billing (i.e., the printing data that is not a billing target).

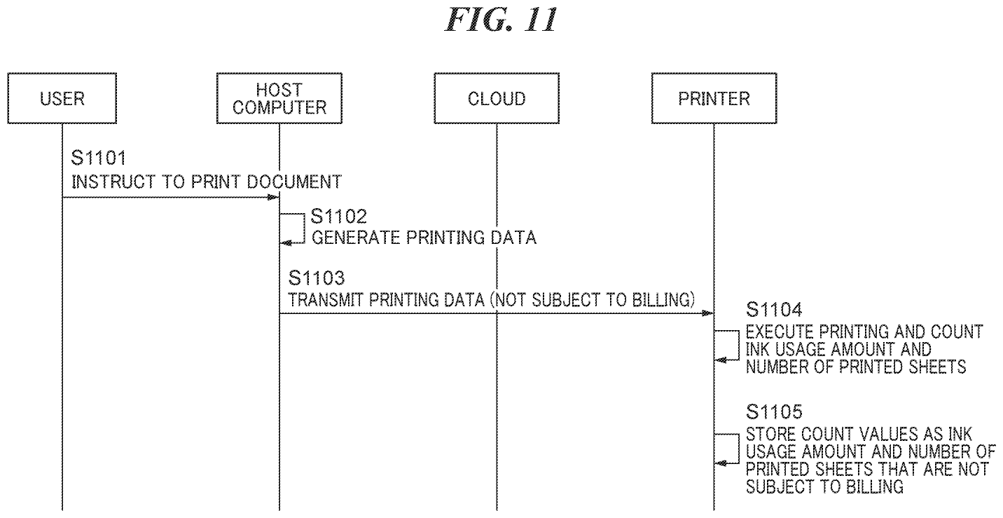

FIG. 11 is a sequence diagram that shows a print processing without via the cloud 103 according to the second embodiment of the present invention, which is executed in the printing system 1. Here, “the print processing without via the cloud 103” shown in FIG. 11 is a processing in which a document that the user has previously saved in the host computer 101 is printed by the printer 102 without via the cloud 103.

The print processing without via the cloud 103 shown in FIG. 11 starts when the user issues a printing instruction of the document stored (saved) in the host computer 101 by using the operation unit (the accepting unit) such as the KB 209 of the host computer 101. It should be noted that, unlike the print processing without via the cloud 103 of FIG. 7 of the first embodiment, the user does not need to log into the host computer 101.

In a step S1101, when the host computer 101 detects the printing instruction of the document stored in the host computer 101, which has been issued by the user, the print processing without via the cloud 103 proceeds to a step S1102 so that the printer 102 performs printing without via the cloud 103.

In the step S1102, the host computer 101 generates printing data based on print settings included in the printing instruction detected in the step S1101, and the document.

In a step S1103, the host computer 101 transmits the printing data generated in the step S1102 to the printer 102. Here, the printing data transmitted to the printer 102 is printing data that is not a billing target and does not include the information indicating that it is a billing target.

In a step S1104, upon receiving the printing data transmitted from the host computer 101 in the step S1102, the printer 102 starts printing of the printing data and starts counting of the ink usage amount and the number of printed sheets. Here, similarly to the first embodiment, to be more precise, the number of printed sheets according to the second embodiment refers to the number of printed sides.

In a step S1105, when the printing started in the step S1104 is completed, the printer 102 ends the counting that is also started in the step S1104. Here, the printing data received in the step S1104 does not include the information indicating that it is a billing target. Therefore, the printer 102 stores the result of the counting completed in the step S1105 in the nonvolatile RAM 255 (a second holding unit) as the count information that is not a billing target. Here, the count information that is not a billing target refers to the ink usage amount and the number of printed sheets when the printing is executed based on the printing data generated in the step S1102. Thereafter, the print processing without via the cloud 103 of FIG. 11 is ended. It should be noted that, unlike the print processing without via the cloud 103 of FIG. 7 of the first embodiment, the count information stored in the nonvolatile RAM 255 in the step S1105 is not associated with the user ID.

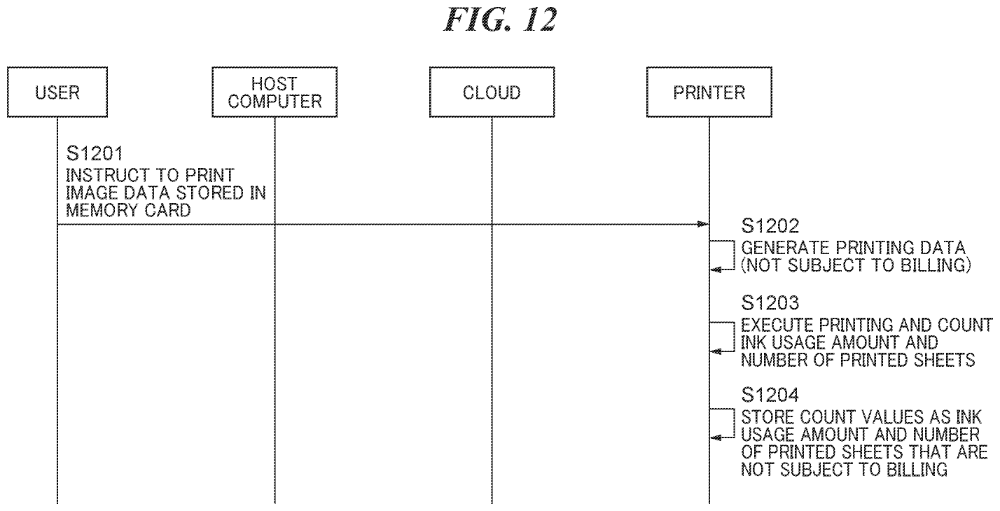

FIG. 12 is a sequence diagram that shows a modification of the print processing without via the cloud 103 shown in FIG. 11, which is executed in the printing system 1. “The print processing without via the cloud 103” in this modification is a print processing in which the user connects the memory card to the printer 102 and image data read from the memory card is printed by the printer 102 without via the cloud 103.

The print processing without via the cloud 103 in this modification starts when the user issues a printing instruction of the image data stored in the memory card connected to the printer 102 by using the operation unit 251 of the printer 102. It should be noted that, unlike the print processing without via the cloud 103 of FIG. 8 of the first embodiment, the user does not need to log into the printer 102.

In a step S1201, when the printer 102 detects the printing instruction of the image data stored in the memory card, which has been issued by the user by using the operation unit 251 (the accepting unit), the print processing without via the cloud 103 in this modification proceeds to a step S1202.

In the step S1202, the printer 102 reads out the image data specified by the printing instruction detected in the step S1201 from the memory card, and generates printing data based on the image data that has been read out and print settings included in the printing instruction detected in the step S1201. Here, the printing data generated by the printer 102 is printing data that is not a billing target and does not include the information indicating that it is a billing target.

In a step S1203, the printer 102 starts printing of the printing data generated in the step S1202 and starts counting of the ink usage amount and the number of printed sheets.

In a step S1204, when the printing started in the step S1203 is completed, the printer 102 ends the counting that is also started in the step S1203. Here, the printing data generated in the step S1203 does not include the information indicating that it is a billing target. Therefore, the printer 102 stores the result of the counting completed in the step S1204 in the nonvolatile RAM 255 (the second holding unit) as the count information that is not a billing target. Here, the count information that is not a billing target refers to the ink usage amount and the number of printed sheets when the printing is executed based on the printing data generated in the step S1203. Thereafter, the print processing without via the cloud 103 of FIG. 12 is ended. It should be noted that, unlike the print processing without via the cloud 103 of FIG. 8 of the first embodiment, the count information stored in the nonvolatile RAM 255 in the step S1204 is not associated with the user ID.

It should be noted that although FIG. 12 shows the sequence for printing the image data recorded on the memory card as a case where printing is executed by the printer 102 alone, the case where printing is executed by the printer 102 alone is not limited to this. In other words, it goes without saying that the print processing without via the cloud 103 of FIG. 12 can be applied to the general printing processes such as copying.

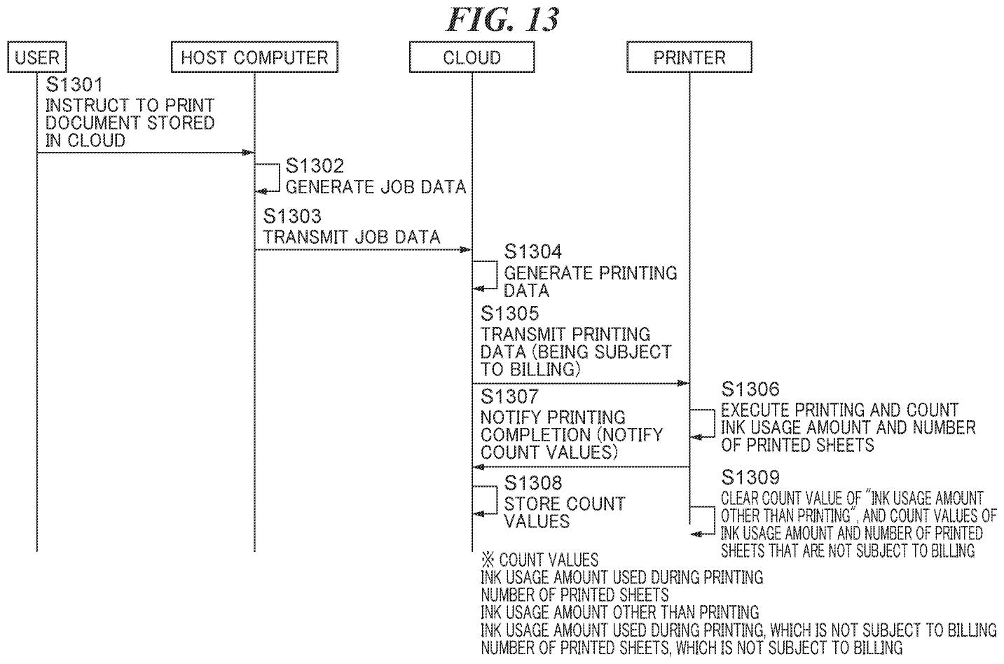

FIG. 13 is a sequence diagram that shows a print processing via the cloud 103 according to the second embodiment of the present invention, which is executed in the printing system 1. Here, “the print processing via the cloud 103” is a print processing executed by the printing system 1 when the user uses the host computer 101 to instruct the cloud 103 to print a document that has been stored (saved) in the cloud 103 in advance.

As in the first embodiment, in the second embodiment as well, the user has previously registered the information regarding the storage service of the cloud 103 that the user is using, in the host computer 101. Therefore, the host computer 101 communicates with the cloud 103 based on this registered information to display a file name and a preview of the document owned by the user in accordance with the user's instruction.

The print processing via the cloud 103 starts when the user, after logging into the host computer 101, issues a printing instruction of the document stored (saved) in the cloud 103.

In a step S1301, when the host computer 101 detects the printing instruction of the document stored in the cloud 103, which has been issued by the user by using the operation unit (the accepting unit) such as the KB 209, the print processing via the cloud 103 proceeds to a step S1302.

In the step S1302, the host computer 101 generates job data, which describes print settings, a URL of the document, an access token for referencing the document, etc. that are included in the printing instruction detected in the step S1301.

In a step S1303, the host computer 101 transmits the job data generated in the step S1302 to the cloud 103.

In a step S1304, upon receiving the job data transmitted from the host computer 101 in the step S1303, the cloud 103 first obtains the document to be printed by using the URL and the access token that have been described in the job data. Next, the cloud 103 generates printing data based on the obtained document and the print settings described in the job data.

In a step S1305, the cloud 103 transmits the printing data generated in the step S1304 to the printer 102. At this time, the cloud 103 embeds the information, which indicates that it is a billing target, in the printing data transmitted to the printer 102.

In a step S1306, upon receiving the printing data transmitted from the cloud 103 in the step S1305, the printer 102 starts printing of the printing data and starts counting of the ink usage amount and the number of printed sheets.

In a step S1307, when the printing started in the step S1306 is completed, the printer 102 ends the counting that is also started in the step S1306. Here, the printing data received in the step S1306 includes the information indicating that it is a billing target. Therefore, the printer 102 determines that the result of the counting completed in the step S1307 is a billing target, and issues the printing completion notification, which includes a user ID of the user logging into the host computer 101 and the count information, to the cloud 103. Here, the count information refers to the result of the counting completed in the step S1307 (the ink usage amount and the number of printed sheets when the printing is executed based on the job data generated in the step S1302), and the ink usage amount for other than printing, which is stored in the nonvolatile RAM 255 through the ink usage amount-for-other-than-printing counting processing of FIG. 5. Furthermore, in the second embodiment, the count information includes the count information that is not a billing target, which has been stored in the step S1105 of FIG. 11 or the step S1204 of FIG. 12. In this way, in the step S1307, the ink usage amount and the number of printed sheets when the printing is executed based on the job data are associated with the user ID and are transmitted to the cloud 103 for each user.

In a step S1308, upon receiving the printing completion notification transmitted from the printer 102 in the step S1307, the cloud 103 stores the count information included in the printing completion notification in order to calculate the fee when performing the billing processing. Thereafter, the cloud 103 transmits the count information reception completion notification (not shown in FIG. 13) to the printer 102.

In a step S1309, upon receiving the count information reception completion notification transmitted from the cloud 103 in the step S1308, the printer 102 resets (clears) the ink usage amount for other than printing and the count information that is not a billing target that have been stored.

Since the sequence when the user confirms the printing fee in the second embodiment is the same as that in the first embodiment (FIG. 9), the description will be omitted.

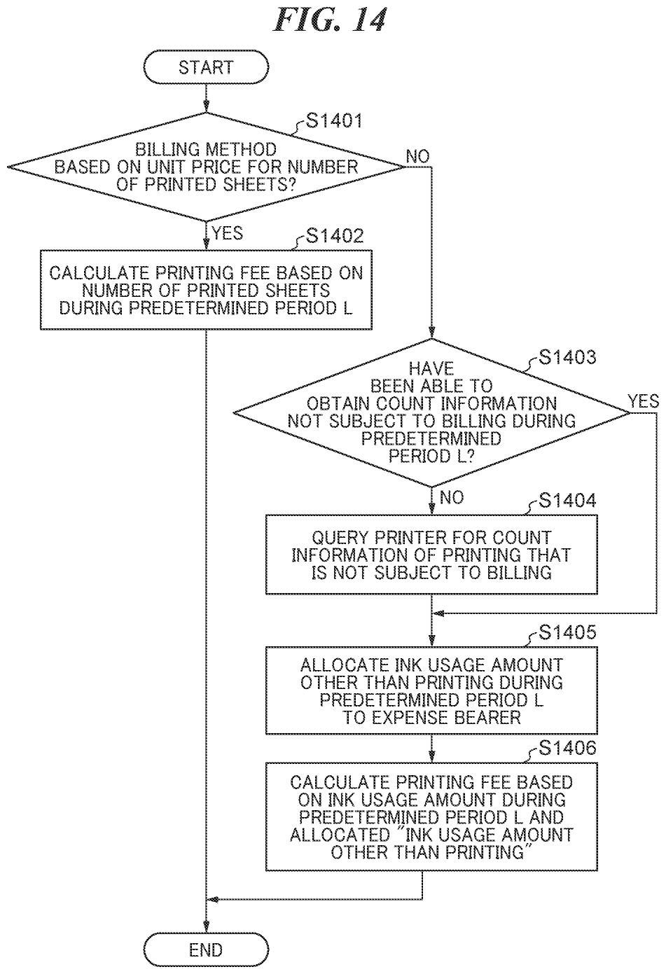

FIG. 14 is a flowchart that shows a printing fee confirmation processing according to the second embodiment of the present invention, which is executed by the cloud 103 (the billing processing server 500) in the step S903 of FIG. 9.

Here, as in the first embodiment, the printing fee is the usage fee for the printing system 1 of the expense bearer during the predetermined period L.

The printing fee calculation processing of FIG. 14 is executed in the billing processing server 500, which is one of the servers constituting the cloud 103, by the CPU 501 reading out the billing processing program stored in the ROM 502 or the external memory 511.

In a step S1401, the CPU 501 confirms the billing method set in advance by the system administrator, and determines whether or not the billing method is the billing method based on the unit price for the number of printed sheets.

In the case that the billing method is the billing method based on the unit price for the number of printed sheets (YES in the step S1401), the printing fee calculation processing of FIG. 14 proceeds to a step S1402. On the other hand, in the case that the billing method is not the billing method based on the unit price for the number of printed sheets (NO in the step S1401), that is, in the case that the billing method is the billing method based on the unit price for the ink usage amount, the printing fee calculation processing of FIG. 14 proceeds to a step S1403.

In the step S1402, the CPU 501 calculates the printing fee of the expense bearer of the user logging into the printing service in the printing fee confirmation processing of FIG. 9 based on the number of printed sheets for each user during the predetermined period L. For example, in the case that the unit price for the number of printed sheets is X and the number of printed sheets is N, X×N will be calculated as the printing fee. Thereafter, the CPU 501 ends the printing fee calculation processing of FIG. 14.

In the step S1403, the CPU 501 determines whether or not the count information that is not a billing target during the predetermined period L (the ink usage amount for printing and the number of printed sheets, which have been stored in the step S1105 of FIG. 11 or the step S1204 of FIG. 12) has been obtained.

In the case that the count information that is not a billing target during the predetermined period L has not been obtained (NO in the step S1403), the printing fee calculation processing of FIG. 14 proceeds to a step S1404, and the CPU 501 inquires of the printer 102 about the ink usage amount for printing and the number of printed sheets, which are stored in the printer 102 and are not billing targets. As a result of this inquiry, after the ink usage amount for printing and the number of printed sheets, which are stored in the printer 102 and are not billing targets, are obtained, the printing fee calculation processing of FIG. 14 proceeds to a step S1405.

On the other hand, in the case that the count information that is not a billing target during the predetermined period L has been obtained (YES in the step S1403), the printing fee calculation processing of FIG. 14 directly proceeds to the step S1405.

In the step S1405, the CPU 501 allocates the ink usage amount for other than printing during the predetermined period L to the expense bearer. For example, the CPU 501 allocates the ink usage amount for other than printing to the expense bearer according to the ratio of the ink usage amount for printing for each user during the predetermined period L. It should be noted that, when performing this allocating, the ink usage amount for printing included in the count information that is not a billing target is treated as having no the expense bearer.

In a step S1406, the CPU 501 calculates the printing fee based on the ink usage amount for printing for the expense bearer during the predetermined period L and the ink usage amount for other than printing that has been allocated in the step S1405. For example, in the case that the unit price for the ink usage amount is Y, the ink usage amount for printing is M1, and the ink usage amount for other than printing that has been allocated in the step S1405 is M2, Y×(M1+M2) will be calculated as the printing fee. Thereafter, the CPU 501 ends the printing fee calculation processing of FIG. 14.

It should be noted that in the second embodiment, in the step S1405, although the ink usage amount for other than printing is allocated to the expense bearer according to the ratio of the ink usage amount for printing for each user, the method of allocating the ink usage amount for other than printing is not limited to this. For example, the ink usage amount for other than printing may be allocated to the expense bearer according to the number of printed sheets for each user. Furthermore, the method of allocating the ink usage amount for other than printing may be initialized in advance, or may be configured to be set in advance by the system administrator on the billing processing server 500.

It should be noted that although FIG. 9 shows the example in which the printing fee is calculated in the step S903, the printing fee confirmation processing shown in FIG. 14 may be automatically executed during the period of time when the processing load on the cloud 103 is light, and the printing fee may be stored in the cloud 103.

As described above, according to the second embodiment, the count information is not notified from the printer 102 to the cloud 103 when printing that is not a billing target is performed. Therefore, in the case of performing the printing that is not a billing target, the user does not need to connect the printer 102 to the cloud 103, which increases convenience. In addition, since the count information for the printing that is not a billing target is later collectively notified to the cloud 103, the notification of personal information, that is, the count information for each job that is not a billing target, to the cloud 103 can be kept to the minimum necessary range. In addition, in the printing system 1, it is possible to change to the billing method also including the ink usage amount for other than printing without changing the configuration of the printing system 1.

It should be noted that, in the embodiment of the present invention, it is also possible to implement processing in which a program for implementing one or more functions is supplied to a computer of a system or an apparatus via a network or a storage medium, and a system control unit of the system or the apparatus reads out and executes the program. The system control unit may include one or more processors or circuits, and in order to read out and execute executable instructions, the system control unit may include multiple isolated system control units or a network of multiple isolated processors or circuits.

The processor or circuit may include a central processing unit (CPU), a micro processing unit (MPU), a graphics processing unit (GPU), an application-specific integrated circuit (ASIC), and/or a field-programmable gate array (FPGA). In addition, the processor or circuit may include a digital signal processor (DSP), a data flow processor (DFP), or a neural processing unit (NPU).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-191979, filed on Nov. 30, 2022, which is hereby incorporated by reference herein in its entirety.

What is claimed is:

1. A printing system that includes a server and a device, the printing system comprising:
an accepting unit configured to accept printing instructions from users;
a printing unit configured to perform printing by an inkjet printing method;
a first counting unit configured to count an ink amount used for printing performed by the printing unit for each user;
a second counting unit configured to count an ink amount used for purposes other than printing performed by the printing unit;
a third counting unit configured to count the number of printed sheets for each user;
a billing method setting unit configured to set a billing method to one of a first method of billing based on a unit price for the number of printed sheets and a second method of billing based on a unit price for an ink amount; and
a billing unit configured to perform a billing processing based on at least one counting result of counting results, which are obtained by the first counting unit, the second counting unit, and the third counting unit, respectively, and
wherein the billing unit, in a case that the billing method set by the billing method setting unit is the first method, calculates a printing fee for an expense bearer according to the number of printed sheets for each user counted by the third counting unit, and
in a case that the billing method set by the billing method setting unit is the second method, calculates the printing fee for the expense bearer according to a sum of the ink amount for each user counted by the first counting unit, and the ink amount used for purposes other than printing that has been counted by the second counting unit and has been allocated to the expense bearer.

2. The printing system according to claim 1, wherein
the device comprises the accepting unit, the printing unit, the first counting unit, the second counting unit, and the third counting unit, and
the server comprises the billing method setting unit and the billing unit.

3. The printing system according to claim 2, wherein
the device further comprises a count information notifying unit configured to notify the server of count information including the counting results, which are obtained by the first counting unit, the second counting unit, and the third counting unit, respectively.

4. The printing system according to claim 1, wherein
the billing unit performs allocating of the ink amount used for purposes other than printing that has been counted by the second counting unit to the expense bearer according to a ratio of the number of printed sheets for each user counted by the third counting unit.

5. The printing system according to claim 1, wherein
the billing unit performs allocating of the ink amount used for purposes other than printing that has been counted by the second counting unit to the expense bearer according to a ratio of the ink amount for each user counted by the first counting unit.

6. The printing system according to claim 1, wherein
the billing unit sets the expense bearer for each user or a department to which the each user belongs.

7. The printing system according to claim 3, wherein
the device further comprises a first holding unit configured to hold the counting result obtained by the second counting unit,
the count information notifying unit notifies the server of the count information upon completion of printing performed by the printing unit in response to the printing instruction accepted by the accepting unit, and
when notification of the count information to the server performed by the count information notifying unit is completed, the first holding unit resets the counting result obtained by the second counting unit, which is held by the first holding unit.

8. The printing system according to claim 3, wherein
the device further comprises
a billing target determining unit configured to determine whether printing data that is a printing target of the printing unit is printing data that is not a billing target or printing data that is a billing target; and
a second holding unit configured to, in a case that the billing target determining unit determines that the printing data that is a printing target is the printing data that is not a billing target, hold the counting results obtained by the first counting unit and the third counting unit, respectively, required for printing of the printing data that is a printing target as count information that is not a billing target without performing notification performed by the count information notifying unit,
in a case that the billing target determining unit determines that the printing data that is a printing target is the printing data that is a billing target, when notifying the counting results obtained by the first counting unit, the second counting unit, and the third counting unit, respectively, required for printing of the printing data that is a printing target as the count information, the count information notifying unit also notifies the server of the count information that is not a billing target, and
when the billing unit performs allocating of the ink amount used for purposes other than printing that has been counted by the second counting unit to the expense bearer, the count information that is not a billing target is treated as having no expense bearer.

9. The printing system according to claim 8, wherein
when notification of the count information to the server performed by the count information notifying unit is completed, the second holding unit resets the count information that is not a billing target.

10. The printing system according to claim 8, wherein
in a case that the printing data that is a printing target is printing data that has been saved in the server, when the server transmits the printing data that is a printing target to the device in response to the printing instruction accepted by the accepting unit, the server embeds information indicating that it is a billing target in the printing data that is a printing target, and
the billing target determining unit,
in a case that the information indicating that it is a billing target has been embedded in the printing data that is a printing target, determines that the printing data that is a printing target is the printing data that is a billing target, and
in a case that the information indicating that it is a billing target has not been embedded in the printing data that is a printing target, determines that the printing data that is a printing target is the printing data that is not a billing target.

11. A device that is connected to a server, the device comprising:
an accepting unit configured to accept printing instructions from users;
a printing unit configured to perform printing by an inkjet printing method;
a first counting unit configured to count an ink amount used for printing performed by the printing unit for each user;
a second counting unit configured to count an ink amount used for purposes other than printing performed by the printing unit;
a third counting unit configured to count the number of printed sheets for each user;
a count information notifying unit configured to notify the server of count information including counting results, which are obtained by the first counting unit, the second counting unit, and the third counting unit, respectively;
a first obtaining unit configured to, in a case that a billing method is a first method of billing based on a unit price for the number of printed sheets, obtain a printing fee for each user according to the number of printed sheets for each user, which has been counted by the third counting unit and is included in the count information, from the server; and
a second obtaining unit configured to, in a case that the billing method is a second method of billing based on a unit price for an ink amount, obtain a printing fee for each user according to a sum of the ink amount for each user counted by the first counting unit and the ink amount used for purposes other than printing that has been counted by the second counting unit and has been allocated for each user, from the server.

12. A control method for a printing system that includes a server and a device, the control method comprising:
an accepting step of accepting printing instructions from users;
a printing step of performing printing by an inkjet printing method;
a first counting step of counting an ink amount used for printing performed in the printing step for each user;
a second counting step of counting an ink amount used for purposes other than printing performed in the printing step;
a third counting step of counting the number of printed sheets for each user;
a count information notifying step of notifying the server of count information including counting results, which are obtained in the first counting step, the second counting step, and the third counting step, respectively;
a billing method setting step of setting a billing method to one of a first method of billing based on a unit price for the number of printed sheets and a second method of billing based on a unit price for an ink amount; and
a billing step of performing a billing processing based on the count information, and
wherein in the billing step, in a case that the billing method set in the billing method setting step is the first method, a printing fee for an expense bearer according to the number of printed sheets for each user counted in the third counting step is calculated, and
in a case that the billing method set in the billing method setting step is the second method, the printing fee for the expense bearer according to a sum of the ink amount for each user counted in the first counting step, and the ink amount used for purposes other than printing that has been counted in the second counting step and has been allocated to the expense bearer, is calculated.
